(19) United States
(12) Patent Application Publication
(10) Pub. No.: US 2026/0135131 A1
(43) Pub. Date: May 14, 2026

(54) REDOX FLOW BATTERY COMPRISING A MEMBRANE FREE CELL STACK

(71) Applicant: Pusan National University Industry-University Cooperation Foundation, Busan (KR)

(72) Inventors: Min Joon PARK, Busan (KR); Hyeok Jun JANG, Jinju-si (KR)

(21) Appl. No.: 19/377,836

(22) Filed: Nov. 3, 2025

(30) Foreign Application Priority Data
Nov. 8, 2024 (KR) 10-2024-0157830

(51) Int. Cl. H01M 8/18; H01M 8/0232; H01M 8/0234; H01M 8/0271; H01M 8/24

(52) U.S. Cl. CPC H01M 8/188; H01M 8/0232; H01M 8/0234; H01M 8/0271; H01M 8/24

(57) ABSTRACT

A redox flow battery with a membrane-free stack includes a pair of outer frames, a pair of bipolar plates positioned between the pair of outer frames, a pair of electrode layers positioned between the pair of bipolar plates, and a separator channel positioned between the pair of electrode layers, wherein during charging, a positive electrode active material and a negative electrode active material are deposited in a solid state on surfaces of the positive electrode and the negative electrode, respectively, and the separator channel allows the electrolyte to pass therethrough freely while separating the pair of electrode layers from each other, and provides a redox flow battery including a cell stack without a ion exchange membrane.

### CROSS-REFERENCE TO RELATED APPLICATION

The present application claims priority under 35 U.S.C. § 119(a) to Korean Patent Application No. 0-2024-0157830 filed in the Korean Intellectual Property Office on Nov. 8, 2024, which is incorporated herein by reference in its entirety.

### TECHNICAL FIELD

The present disclosure relates to a redox flow battery comprising a cell stack without an ion exchange membrane, and more particularly, to a redox flow battery comprising a cell stack without an ion exchange membrane, wherein both a positive electrode active material and a negative electrode active material use an active material that is deposited during charging, thereby maintaining a sufficient distance so that each electrode does not cause an electrical short circuit, and maintaining a capacity even during charging of the electrode, without using a ion exchange membrane that has been used conventionally.

### BACKGROUND ART

Recently, as a countermeasure against global warming, the introduction of new energy sources, such as photovoltaic power generation and wind power generation, is being promoted worldwide. Since the power output of these power generations is affected by the weather, if a large amount of power is introduced, it is predicted that there will be a problem in the operation of the power system that makes it difficult to maintain the frequency and voltage. As one of the countermeasures for this problem, it is expected that a large-capacity power storage device is installed to smooth the output variation, store surplus power, and level the load.

As one of the large capacity batteries, there is a redox flow battery. The redox flow battery supplies a positive electrode electrolyte and a negative electrode electrolyte to a battery cell having an ion exchange membrane between a positive electrode and a negative electrode, and charges and discharges the battery cell. As the electrolyte, an aqueous solution containing metal ions whose valence changes by oxidation-reduction is typically used. In addition to an iron-chromium redox flow battery using iron ions for a positive electrode and chromium ions for a negative electrode, a vanadium-based redox flow battery using vanadium ions for both the positive and negative electrodes is representative.

In conventional iron-chromium redox flow batteries or vanadium redox flow batteries, an ion conductive diaphragm capable of selectively permeating only specific ions is required to eliminate the charge imbalance generated during the redox process of the positive and negative electrodes.

This ion exchange membrane is designed to prevent the electrolyte including the positive and negative electrode active materials from being mixed. However, the conventional diaphragm has problems in that it is easily oxidized, has a short lifespan, is expensive, and its electrical resistance cannot be too high.

In order to improve the current efficiency of the battery, it is required to prevent as much as possible the permeation of each active material ion (contaminant of electrolyte in the cathode electrolyte) included in the cell electrolyte of the cathode, but a proton (H +) carrying a charge is required to have an ion-exchange membrane having excellent ion-selective permeability that is easily permeable.

In addition, in the case of a redox flow battery such as a vanadium-based redox flow battery, the charged active material is dissolved in the electrolyte. In this case, when the positive electrode active material is charged, it acts as an oxidizing agent, and when the negative electrode active material is charged, it acts as a reducing agent, so immediate discharge occurs when there is no ion exchange membrane.

Alternatively, if the charged products are deposited in a solid form on both the positive and negative electrodes, an ion exchange membrane is not required. Therefore, the present inventors have completed the present disclosure by developing a membrane-free cell stack and a method of manufacturing a redox flow battery to solve the problems of the redox flow battery as described above.

### Technical Problem to be Solved

A technical subject to be achieved by the present disclosure is to provide a redox flow battery including a membrane-free cell stack, which uses active materials deposited during charging for both a positive electrode and a negative electrode, thereby maintaining a sufficient distance to prevent electrical short circuits between the electrodes and maintaining capacity even during charging of the electrodes, without using a conventional ion exchange membrane.

Technical subjects achievable from the present disclosure are not limited to the aforementioned technical subjects and still other technical subjects not described herein may be clearly understood by one of ordinary skill in the art to which the present disclosure pertains from the following description.

### Means for Solving the Problem

To achieve the above technical problem, one embodiment of the present disclosure provides a redox flow battery including a cell stack without a ion exchange membrane.

The redox flow battery including the cell stack without a ion exchange membrane according to an embodiment of the present disclosure,
a pair of outer frames; a pair of bipolar plates located between the pair of outer frames; a pair of electrode layers located between the pair of bipolar plates; and an ion exchange membrane located between the pair of electrode layers.

When charging, a positive active material and a negative active material are deposited in a solid state on surfaces of a positive electrode and a negative electrode, respectively, and the ion exchange membrane allows the electrolyte to pass therethrough freely while separating the pair of electrode layers from each other, and may include a cell stack without a ion exchange membrane, and a redox flow battery.

Further, according to an embodiment of the present disclosure, there may be provided a redox flow battery including a membrane-free cell stack, further including a flow path through which an electrolyte can flow, wherein the electrolyte circulates through the membrane-free cell stack through the flow path.

Also, according to an embodiment of the present disclosure, the outer frame and the bipolar plate may include a through portion through which the flow path can pass and may include a redox flow battery including a membrane-free cell stack.

Additionally, according to an embodiment of the present disclosure, there may be a redox flow battery including a cell stack without a ion exchange membrane, wherein the bipolar plate is made of a conductive material having high oxidation resistance.

Also, according to an embodiment of the present disclosure, the bipolar plate may include at least one selected from the group consisting of graphite and Ti, and a redox flow battery including a membrane-free cell stack.

According to an embodiment of the present disclosure, the pair of electrode layers includes an electrode and an electrode frame, wherein the electrode frame fixes the electrode and prevents leakage of the electrolyte, and a cell stack without a ion exchange membrane may be included.

In addition, according to an embodiment of the present disclosure, the electrode frame may be made of a non-conductive plastic, and a redox flow battery including a membrane-free cell stack may be provided.

The electrode may be one selected from the group consisting of carbon felt, carbon paper, carbon cloth, metal mesh, metal plate, and metal foam, and a redox flow battery including a cell stack without an ion exchange membrane.

Further, according to an embodiment of the present disclosure, it may further include a fluororubber sheet, wherein the fluororubber sheet may be selectively located between the respective components, and serves to prevent the electrolyte from leaking to the outside through a connection part between the respective components, and a cell stack without an ion exchange membrane.

Also, according to an embodiment of the present disclosure, the configurations are assembled to form a single cell stack unit, and a plurality of the cell stack units are connected in parallel or in series to adjust the output of the redox flow battery, and a redox flow battery including a cell stack without an ion exchange membrane.

According to an embodiment of the present disclosure, the ion exchange membrane has a partitioned structure divided at regular intervals, and each partition serves as a passage through which the electrolyte can freely pass, and a redox flow battery including a membrane-free cell stack.

Additionally, according to an embodiment of the present disclosure, each compartment of the ion exchange membrane may include a redox flow battery including a membrane-free cell stack, characterized in that each compartment of the ion exchange membrane has a porous mesh structure.

Additionally, according to an embodiment of the present invention, the ion exchange membrane may have a thickness of 0.5 mm to 4 mm, and a redox flow battery including a membrane-free cell stack.

Also, according to an embodiment of the present disclosure, the positive electrode active material is deposited in a solid state on the surface of the positive electrode during charging, and includes at least one metal selected from the group consisting of Mn, Ce, Co, Zn, Ti, Fe, Ni, Cu, Tc, and Mo in an ionic state, and a cell stack without an ion exchange membrane.

According to an embodiment of the present disclosure, the cathode active material is deposited in a solid state on the surface of the cathode during charging, and includes at least one metal selected from the group consisting of Mn, Ce, Co, Zn, Ti, Fe, Ni, Cu, Tc, and Mo in an ionic state, and a cell stack including no ion exchange membrane.

### Effects of the Invention

According to an embodiment of the present disclosure, by using an active material deposited during charging for both a positive electrode active material and a negative electrode active material, a redox flow battery including a membrane-free cell stack is provided, which can maintain a sufficient distance so that each electrode does not cause an electrical short, and can maintain capacity even during charging of the electrode, without using a conventional ion exchange membrane.

According to an embodiment of the present disclosure, by solving the performance degradation of the redox flow battery due to the diaphragm generated during operation, it is possible to provide a redox flow battery that can be operated for a long time.

According to an embodiment of the present disclosure, the manufacturing cost can be reduced by not using an expensive conventional diaphragm structure.

The effects of the present disclosure are not limited to the above-mentioned effects, and it should be understood that the present disclosure includes all effects that can be inferred from the detailed description of the present disclosure or the configuration of the disclosure described in the claims.

### BRIEF DESCRIPTION OF THE DRAWINGS

FIG. 1 is a schematic diagram illustrating an external frame of a redox flow battery stack according to an embodiment of the present disclosure.

FIG. 2 is a schematic diagram illustrating a bipolar plate, an electrode frame, an electrode, and an assembly of the electrode and the electrode frame of a redox flow battery stack according to an embodiment of the present disclosure, respectively.

FIG. 3 is a schematic diagram illustrating a diaphragm of a conventional redox flow battery stack and a separator channel of a redox flow battery stack according to an embodiment of the present disclosure.

FIG. 4 is a schematic diagram illustrating a bipolar plate and a separator channel of a redox flow battery stack overlapped according to an embodiment of the present disclosure.

FIG. 5 is a schematic diagram illustrating a redox flow battery stack using an ion exchange membrane and a redox flow battery stack using a separator channel instead of the ion exchange membrane, respectively.

FIG. 6 is a graph showing the electrochemical impedance spectroscopy (EIS) of a redox flow battery according to the presence of an ion exchange membrane and an electrode gap.

FIG. 7 is a graph showing charge/discharge life of a membrane-free redox flow battery according to an embodiment of the present disclosure.

### DETAILED DESCRIPTION OF THE INVENTION

Hereinafter, the present disclosure will be described with reference to the accompanying drawings. However, the present disclosure may be implemented in various different forms, and is not limited to the embodiments described herein, but is to be understood as including all changes, equivalents, and substitutes included in the spirit and technical scope of the present disclosure.

In the drawings, parts irrelevant to the description are omitted to clearly describe the present disclosure, and like reference numerals denote like elements throughout the specification.

Throughout the disclosure, when a part is said to be “connected to (accessed to, contacted to, coupled to)” another part, it includes not only the case of being directly connected, but also the case of being indirectly connected with another member interposed therebetween.

In addition, when it is said that a part of a layer, film, region, plate, etc. is “on” another part, it includes not only the case where it is directly on the other part but also the case where there is another part in between. Also, in the present specification, when it is said that a part of a layer, film, region, plate, etc. is formed on another part, the direction of formation is not limited to the upward direction and includes formation in the lateral or downward direction. Conversely, when it is said that a part of a layer, film, region, plate, etc. is “under” another part, it includes not only the case where it is directly under the other part but also the case where there is another part in between.

In the present disclosure, ‘upper surface’ and ‘lower surface’ are used as relative concepts to easily explain the technical idea of the present disclosure. Therefore, ‘upper surface’ and ‘lower surface’ do not refer to a specific direction, position, or component and may be used interchangeably.

For example, the “upper surface” may be interpreted as the “lower surface”, and the “lower surface” may be interpreted as the “upper surface”. Therefore, the “upper surface” may be expressed as “first” and the “lower surface” may be expressed as “second”, or the “lower surface” may be expressed as “first” and the “upper surface” may be expressed as “second”. However, within one embodiment, the “upper surface” and the “lower surface” are not used interchangeably.

Unless defined otherwise, all terms used herein, including technical or scientific terms, have the same meaning as commonly understood by one of ordinary skill in the art to which this disclosure belongs. Terms as defined in commonly used dictionaries should be interpreted as having a meaning consistent with their contextual meaning in the relevant art and, unless explicitly defined herein, should not be interpreted in an ideal or overly formal sense.

Also, when a part “comprises” an element, it means that the part may further include other elements, not excluding other elements unless specifically stated to the contrary.

The terms used in the present disclosure are used only to describe a specific embodiment and are not intended to limit the present disclosure. The singular expression includes the plural expression unless it is clearly meant otherwise in the context. In the present disclosure, terms such as “comprise” or “have” are intended to designate the existence of features, numbers, steps, actions, components, parts, or combinations thereof described in the disclosure, but do not preclude the possibility of the existence or addition of one or more other features, numbers, steps, actions, components, parts, or combinations thereof.

Hereinafter, embodiments of the present disclosure will be described in detail with reference to the accompanying drawings.

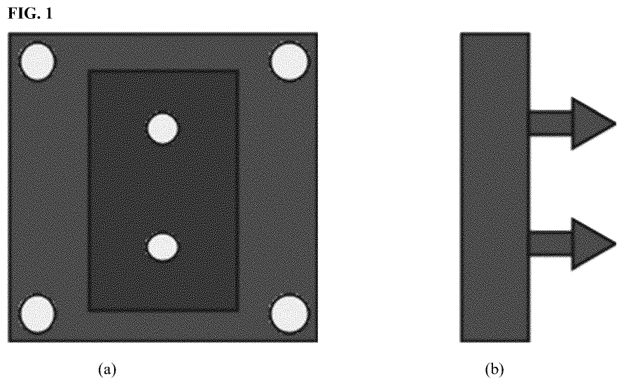

FIG. 1 is a schematic diagram illustrating an external frame of a redox flow battery stack according to an embodiment of the present disclosure.

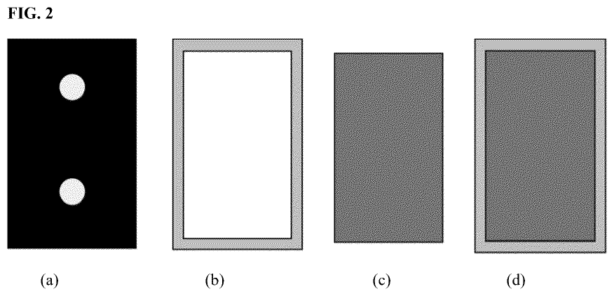

FIG. 2 is a schematic diagram illustrating a bipolar plate, an electrode frame, an electrode, and an assembly of the electrode and the electrode frame of a redox flow battery stack according to an embodiment of the present disclosure, respectively.

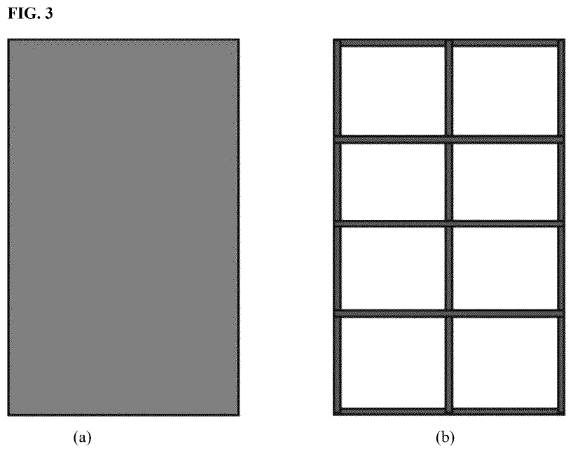

FIG. 3 is a schematic diagram illustrating a diaphragm of a conventional redox flow battery stack and a separator channel of a redox flow battery stack according to an embodiment of the present disclosure.

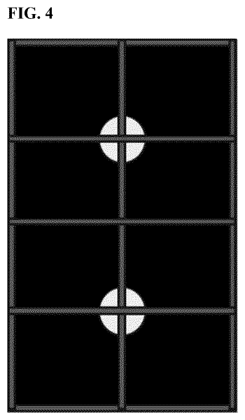

FIG. 4 is a schematic diagram illustrating a bipolar plate and a separator channel of a redox flow battery stack overlapped according to an embodiment of the present disclosure.

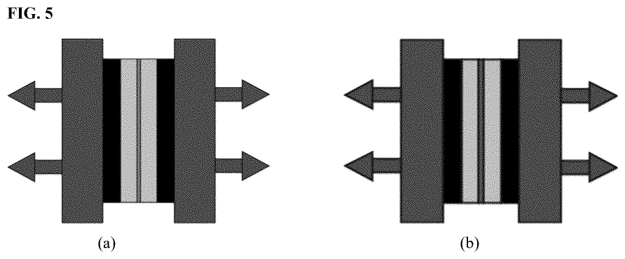

FIG. 5 is a schematic diagram illustrating a redox flow battery stack using an ion exchange membrane and a redox flow battery stack using a separator channel instead of the ion exchange membrane, respectively.

FIG. 1 to FIG. 5, a redox flow battery including a membrane-free cell stack according to an embodiment of the present disclosure is described.

The configuration includes: a pair of outer frames; a pair of bipolar plates located between the pair of outer frames; a pair of electrode layers located between the pair of bipolar plates; and an ion exchange membrane located between the pair of electrode layers.

There may be a redox flow battery including a cell stack without an ion exchange membrane, wherein during charging, a positive electrode active material and a negative electrode active material are deposited in a solid state on surfaces of a positive electrode and a negative electrode, respectively, and the ion exchange membrane allows the electrolyte to pass therethrough freely while separating the pair of electrode layers from each other.

Prior to this, a conventional redox flow battery was charged and discharged by supplying a positive electrode electrolyte and a negative electrode electrolyte to a battery cell having an ion exchange membrane between a positive electrode and a negative electrode. In conventional iron-chromium redox flow batteries or vanadium redox flow batteries, an ion conductive diaphragm capable of selectively permeating only specific ions was required to eliminate the charge imbalance generated during the redox process of the positive and negative electrodes.

The ion exchange membrane is designed to prevent mixing of the electrolyte solutions containing positive and negative active materials.

In addition, in order to improve current efficiency of the battery, it is required to prevent as much as possible permeation of each active material ion (contaminant of electrolyte in cathode electrolyte) included in the cell electrolyte of the cathode, but a proton (H+) carrying electric charge is required to have an ion-exchange membrane having excellent ion selective permeability, which is easily permeable.

In addition, in the case of a redox flow battery such as a vanadium-based redox flow battery, the charged active material is dissolved in the electrolyte.

In this case, when the positive electrode active material is charged, it acts as an oxidizing agent, and when the negative electrode active material is charged, it acts as a reducing agent, so discharge occurs immediately when there is no ion exchange membrane.

Alternatively, in the case of conventional redox flow batteries, a partition membrane, named as an ion exchange membrane, was necessarily required, and the crossover of the electrolyte itself through the partition membrane was maximally suppressed.

However, the diaphragm has a problem in that it is easily oxidized, has a short lifespan, is expensive, and its electrical resistance must be sufficiently low.

The biggest difference between the redox flow battery according to an embodiment of the present disclosure and a conventional redox flow battery is whether or not the ion exchange membrane structure is included.

A redox flow battery according to an embodiment of the present disclosure has a main technical feature of including a cell stack without the ion exchange membrane.

As described above, a configuration of a separator channel is applied instead of a diaphragm.

FIG. 3 shows the structural difference between the diaphragm and the separation plate.

Referring to FIG. 3, in the case of the ion exchange membrane applied in one embodiment of the present disclosure, it can be confirmed that unlike the diaphragm, the ion exchange membrane has a structure through which the electrolyte can freely permeate.

More specifically, first, referring to FIG. 1, the structure of the front (a) and side (b) of the outer frame can be confirmed.

As can be seen through (b) of FIG. 1, as an example of the embodiment, it may further include a flow path through which an electrolytic solution may flow;

There may be a redox flow battery including a membrane-free cell stack, wherein an electrolyte circulates through the channel and through the inside of the membrane-free cell stack.

At this time, the outer frame may have a through portion through which the flow path can pass, and as shown in (a) of FIG. 1, the through portion is provided at the center of the outer frame, and it can be seen that the flow path is connected through the through portion.

Additionally, the structure of the bipolar plate can be confirmed through (a) of FIG. 2.

The bipolar plate may also have a through portion through which the flow path can pass, similarly to the outer frame.

In (a) of FIG. 2, it can be seen that a through portion is provided in a central portion of the bipolar plate, and the flow path may be connected through the through portion.

At this time, the bipolar plate may be characterized in that it is made of a conductive material with high oxidation resistance.

More specifically, the bipolar plate includes at least one selected from the group consisting of a graphite material and a Ti material, and a redox flow battery including a cell stack without an ion exchange membrane.

As an example of the embodiment, the pair of electrode layers includes an electrode and an electrode frame, wherein the electrode frame fixes the electrode and prevents leakage of the electrolyte, and a cell stack without an ion exchange membrane includes a redox flow battery.

Referring to (b) to (d) of FIG. 2, the structure of the electrode, the electrode frame, and an assembly in which the electrode and the electrode frame are coupled can be confirmed.

As shown in (d) of FIG. 2, when the electrode and the electrode frame are used in combination, the electrode frame not only fixes the electrode but also serves to prevent the electrolyte from leaking to the outside.

At this time, the electrode frame may be made of non-conductive plastic, silicon, wood, etc. In particular, if fluorine-based plastic (PTFE, etc.) is used among non-conductive plastics, chemical resistance can be ensured to prevent leakage of the electrolytic solution.

The electrode is one selected from the group consisting of carbon felt, carbon paper, carbon cloth, metal mesh, metal plate, and metal foam, and a redox flow battery including a membrane-free cell stack.

In the case of the metal, any material commonly used as an electrode material may be used.

As an example of the above-described embodiment, it may further include a fluororubber sheet;
The fluorocrubber sheet may be optionally provided between the respective components and serves to prevent the electrolyte from leaking to the outside through a connection part between the components and a redox flow battery including a membrane-free cell stack.

As an example of the embodiment, the structures are assembled to form a single cell stack unit, and a plurality of the cell stack units are connected in parallel or in series to adjust an output of the redox flow battery, and a membrane-free cell stack may be included in the redox flow battery.

In this case, when the cell stack units are connected in parallel to each other, the capacity of the entire redox flow battery increases, and when connected in series, the voltage of the entire redox flow battery increases.

As an example of the embodiment, the ion exchange membrane has a compartment structure divided at regular intervals, and each compartment serves as a passage through which the electrolyte can freely pass, and a redox flow battery including a membrane-free cell stack.

The separator channel is a configuration entirely different from a configuration such as an ion exchange membrane that simply allows ions to pass through, and is a configuration that allows the electrolyte itself to pass through freely.

As shown in (b) of FIG. 3, the separator channel has a compartmentalized structure divided at regular intervals.

In this case, each of the partitions may have a porous mesh structure.

FIG. 4 is a bipolar plate and an overlapping ion exchange membrane of a redox flow battery stack without a diaphragm.

Referring to FIG. 4, since the ion exchange membrane may partially block the internal electrolyte flow, the area of the partition due to the ion exchange membrane should be constant so that the electrolyte flow can be distributed over the entire electrode area, and a path through which the electrolyte flow can pass should be ensured.

In addition, while maintaining the aforementioned flow, the ion exchange membrane must maintain a thin thickness while maintaining the physical distance between the positive electrode and the negative electrode.

Accordingly, the separator channel may have a thickness of 0.5 mm to 4 mm. When the ion exchange membrane has a thickness of less than 0.5 mm, there is a problem that the electrodes may move due to the flow of the electrolytic solution or the like, thereby releasing the physical isolation between the positive electrode and the negative electrode.

On the other hand, if the ion exchange membrane has a thickness of more than 4 mm, problems may occur in terms of electrochemical efficiency (coulomb efficiency, etc.) and physical efficiency (excessive volume increase) of the cell stack.

As an example of the embodiment, the positive active material is deposited in a solid state on the surface of the positive electrode during charging, and includes at least one metal selected from the group consisting of Mn, Ce, Co, Zn, Ti, Fe, Ni, Cu, Tc, and Mo in an ionic state, and a membrane-free cell stack.

At this time, the positive active material may be deposited in a solid state by undergoing an oxidation reaction on the surface of the positive electrode during charging, combining with oxygen chemical species included in the solvent to form a metal oxygen oxide (oxidized metal).

Also, the electrolyte of the redox flow battery may further include an additive composed of organic molecular ions (such as amino acids) or inorganic ions (such as metal ions).

When the organic molecular ions (such as amino acids) or inorganic ions (metal ions) are further included in the electrolyte, the metal ions included in the cathode active material may cause a deposition reaction to form a metal, which may be deposited in a solid state by adjusting the electron density of the active material ions through a coordination bond or modifying a hydration environment.

As an example of the embodiment, the negative active material is deposited in a solid state on a surface of the negative electrode during charging, and includes one or more metals selected from the group consisting of Mn, Ce, Co, Zn, Ti, Fe, Ni, Cu, Tc, and Mo in an ionic state, and a cell stack including no ion exchange membrane.

At this time, the negative active material can be deposited in a solid state by being combined with oxygen chemical species included in a solvent through a reduction reaction on a surface of the negative electrode during charging to form a metal oxygen oxide (oxidized metal).

Also, the electrolyte of the redox flow battery may further include an additive composed of organic molecular ions (such as amino acids) or inorganic ions (such as metal ions).

When the organic molecular ions (such as amino acids) or inorganic ions (metal ions) are further included in the electrolyte, the metal ions included in the cathode active material may cause a deposition reaction to form a metal, which may be deposited in a solid state by adjusting the electron density of the active material ions through a coordination bond or modifying a hydration environment.

### Comparative Example 1. Redox Flow Battery Stack Using an Ion Exchange Membrane

(a) of FIG. 3 may have a redox flow battery stack having a structure as shown in (a) of FIG. 5.

The redox flow battery stack outer frame has a hole through which a bolt can be fixed, and a pipe through which the electrolyte can be circulated.

Graphite was used as the bipolar plate.

The bipolar plate also has a hole through which the electrolyte can circulate.

Carbon felt was used as the electrode, and it is assembled with the electrode frame.

As shown in (a) of FIG. 5,
A pair of electrode/electrode frame assemblies is placed on both sides of the ion exchange membrane, and a pair of bipolar plates is placed on an outer surface of the electrode & electrode frame assembly pair.
   After placing a pair of outer frames on the outer surface of the bipolar plate pair, the above structure is fixed.

### Example 1. Redox Flow Battery Stack Using a Separator Channel Instead of an Ion Exchange Membrane

(b) of FIG. 3 shows an example of a separator channel, where there may be a redox flow battery stack having a structure as shown in (b) of FIG. 5.

The redox flow battery stack outer frame has a hole through which a bolt can be fixed, and a pipe through which the electrolyte can be circulated.

Graphite was used as the bipolar plate.

The bipolar plate also has a hole through which the electrolyte can circulate.

Carbon felt was used as the electrode, and it is assembled with the electrode frame.

Like the structure of (b) of FIG. 5,
A pair of electrode-electrode frame assemblies are placed on both sides of the separator channel,
   and a pair of bipolar plates is placed on an outer surface of the electrode & electrode frame assembly pair.

After placing a pair of outer frames on the outer surface of the bipolar plate pair, the above structure is fixed.

At this time, the separator channels were fabricated to have thicknesses of 3 mm and 1 mm, respectively.

### Experimental Example 1. Analysis of Electrochemical Properties of Redox Flow Battery

A redox flow battery stack using an ion exchange membrane instead of the separator channel of Comparative Example 1 was connected to a pump and an electrolyte tank, and a redox flow battery using a carbon felt electrode and an electrolyte (0.1M ZnCl2, 0.1M MnCl2, 3.0M NaCl, 0.05M Aspartic Acid Monosodium salt) was fabricated, and based on this, electrochemical properties were analyzed.

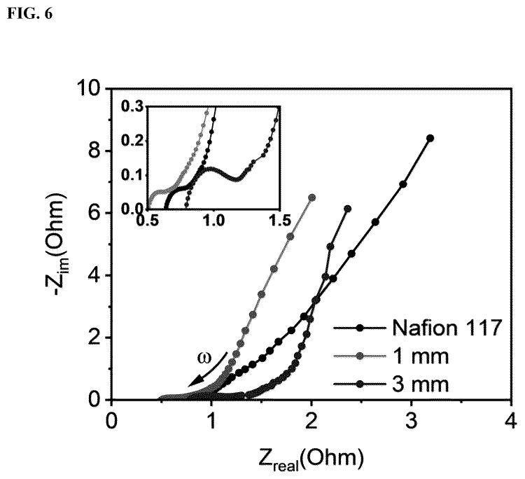

FIG. 6 is a graph showing the electrochemical impedance spectroscopy (EIS) of the redox flow battery according to the presence of an ion exchange membrane and an electrode gap (measured from 0.01 Hz to 100,000 Hz).

Referring to FIG. 6, it is possible to compare EIS graphs of a membrane-free redox flow battery having an ion exchange membrane thickness of 3 mm and 1 mm, and a redox flow battery with an ion exchange membrane, respectively.

More specifically, in the case of Nafion 117, it can be confirmed that the electrolyte resistance Rel is 0.6 Ω, and the electrolyte resistance Rel is 0.4 Ω or more.

When the thickness of the separator channel is 3 mm, it can be confirmed that the electrolyte resistance Rel is 0.8 Ω and the electrolyte resistance Rel is 0.5 Ω.

When the ion exchange membrane thickness is 1 mm, it can be confirmed that the electrolyte resistance Rel is 0.5 Ω and the electrolyte resistance Rel is 0.1 Ω.

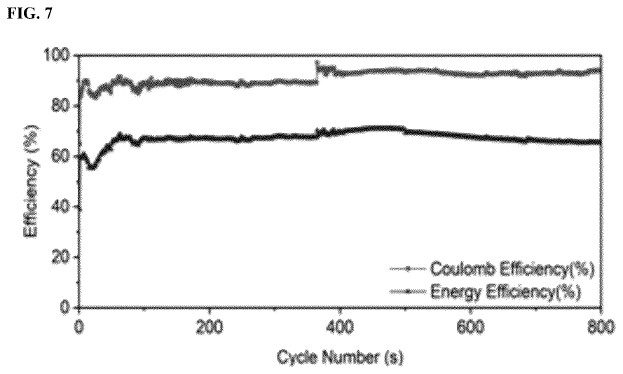

FIG. 7 is a graph showing charge/discharge life of a membrane-free redox flow battery according to an embodiment of the present disclosure.

FIG. 7 illustrates repeated charging and discharging using a redox flow battery with a separator channel according to an embodiment of the present disclosure, wherein the surface capacity was limited to 2.2 mAh/cm2 during charging/discharging, a current density was set to 20mA/cm2 , and voltage behavior was observed.

Referring to FIG. 7, it can be seen that the Coulomb efficiency is stably maintained at 90% or more even after 800 cycles without significant change.

Energy efficiency is also maintained at 60% or more stably without significant change even after 800 cycles.

This means that the redox flow battery using an ion exchange membrane instead of the membrane structure according to an embodiment of the present disclosure can operate without performance degradation for a long lifespan.

The above description of the present disclosure is for illustrative purposes, and those skilled in the art will understand that the present disclosure can be easily modified into other specific forms without changing the technical spirit or essential features of the present disclosure. Therefore, the embodiments described above should be understood as illustrative in all aspects and not limiting. For example, each component described as a single unit may be implemented in a distributed manner, and similarly, components described as distributed may be implemented in a combined form.

The scope of the present disclosure is defined by the appended claims, and it should be construed that all changes or modifications derived from the meaning and scope of the claims and equivalent concepts are included in the scope of the present disclosure.

What is claimed is:

1. A redox flow battery with a membrane-free cell stack comprising:
a pair of outer frames;
a pair of bipolar plates positioned between the pair of outer frames;
a pair of electrode layers located between the pair of bipolar plates; and
a separator channel located between the pair of electrode layers;
wherein during charging, a positive electrode active material and a negative electrode active material is deposited in a solid state on a surface of the positive electrode and the negative electrode, respectively, and
wherein the separator channel separates the pair of electrode layers from each other, while allowing free permeation of an electrolyte.

2. The redox flow battery of claim 1, further comprising,
a channel through which the electrolyte can flow;
wherein the electrolyte circulates through the channel and through the membrane-free cell stack.

3. The redox flow battery of claim 2,
wherein the external frame and the bipolar plate have through parts through which the channel can pass.

4. The redox flow battery of claim 1,
wherein the bipolar plate is made of a conductive material having high oxidation resistance.

5. The redox flow battery of claim 4,
wherein the bipolar plate comprises at least one selected from groups consisting of graphite and Ti.

6. The redox flow battery of claim 1,
wherein the pair of electrode layers comprise:
an electrode, and
an electrode frame, wherein the electrode frame fixes the electrode and prevents leakage of the electrolyte.

7. The redox flow battery of claim 6,
wherein the electrode frame is made of a non-conductive plastic.

8. The redox flow battery of claim 6,
wherein the electrode is one selected from groups consisting of carbon felt, carbon paper, carbon cloth, metal mesh, metal plate, and metal foam.

9. The redox flow battery of claim 1, further comprising:
a fluoric rubber sheet, wherein the fluoric rubber sheet is optionally located between the respective components and serves to prevent the electrolyte from leaking to the outside through a connection portion between the components.

10. The redox flow battery of claim 1,
wherein the components are assembled to form a single cell stack unit, and
wherein a plurality of the single cell stack units are connected in parallel or in series with each other to control an output of the stack of the redox flow battery.

11. The redox flow battery of claim 1,
wherein the separator channel has a partition divided at regular intervals, and each partition serves as a passage through which the electrolyte can freely pass.

12. The redox flow battery of claim 11,
wherein each partition of the separator channel has a porous mesh structure.

13. The redox flow battery of claim 1,
wherein the separator channel has a thickness of 0.5 mm to 4 mm.

14. The redox flow battery of claim 1,
wherein the cathode active material comprises at least one metal selected from the group consisting of Mn, Ce, Co, Zn, Ti, Fe, Ni, Cu, Tc, and Mo in an ionic state.

15. The redox flow battery of claim 1,
wherein the negative electrode active material comprises at least one metal selected from the group consisting of Mn, Ce, Co, Zn, Ti, Fe, Ni, Cu, Tc, and Mo in an ionic state.
